(19) United States
(12) Patent Application Publication
(10) Pub. No.: US 2020/0233561 A1
(43) Pub. Date: Jul. 23, 2020

(54) INTERACTIONS WITH THREE-DIMENSIONAL (3D) HOLOGRAPHIC FILE STRUCTURES

(71) Applicant: INTERNATIONAL BUSINESS MACHINES CORPORATION, Armonk, NY (US)

(72) Inventors: ERIC V. KLINE, ROCHESTER, MN (US); SARBAJIT K. RAKSHIT, KOLKATA (IN)

(21) Appl. No.: 16/253,916

(22) Filed: Jan. 22, 2019

(51) Int. Cl. G06F 3/0481; G06F 3/0482

(52) U.S. Cl. CPC G06F 3/04815; G06F 3/0482

(57) ABSTRACT

A method for interacting with holographic objects representing a hierarchy includes grouping a plurality of digital content items hosted by a device into a plurality of groups based on an organizational scheme. A holography module of the device outputs one or more holographic objects representing the plurality of digital content items in three-dimensional space. The one or more holographic objects are outputted in accordance with the organizational scheme. The device detects user's selection of one of the holographic objects representing one of the plurality of digital content items. The holography module determines a desired operation to be performed on the selected digital content item based on user's input. The desired operation is performed on the selected holographic object within the three-dimensional space.

### BACKGROUND

The present invention relates to holographic object interaction and, more specifically, interactions with three-dimensional (3D) holographic file structures.

Holographic 3D objects can be projected in mid-air. Users can interact with the holographic objects with finger touch and/or various gestures. Holographic projectors installed in a surrounding can collaborate with each other to project 3D holographic objects in a 3D space. Typically, collaboration of these holographic projectors enables movement of various 3D holographic objects from one point to another within a holographic display. Holographic objects can be used for gaming, simulations of various 3D models, assembling of holographic particles to create a larger 3D model, and the like. In addition, 3D holographic objects are useful in presenting various hierarchies, such as, file structures.

What is needed is a method enabling an efficient navigation of hierarchies represented by 3D holographic objects.

### SUMMARY

Embodiments of the present invention are directed to a computer-implemented method for interacting with holographic objects representing a hierarchy. A non-limiting example of the computer-implemented method includes grouping a plurality of digital content items hosted by a mobile device into a plurality of groups based on an organizational scheme. A holography module of the device outputs one or more holographic objects representing the plurality of digital content items in three-dimensional space. The one or more holographic objects are outputted in accordance with the organizational scheme. The device detects user's selection of one of the holographic objects representing one of the plurality of digital content items. The device determines a desired operation to be performed on the selected digital content item based on user's input. The desired operation is performed on the selected holographic object within the three-dimensional space.

Embodiments of the present invention are directed to a system for interacting with holographic objects representing a hierarchy. A non-limiting example of the system includes a memory having computer-readable instructions and one or more processors for executing the computer-readable instructions. The computer-readable instructions include grouping a plurality of digital content items hosted by a mobile device into a plurality of groups based on an organizational scheme. A holography module of the device outputs one or more holographic objects representing the plurality of digital content items in three-dimensional space. The one or more holographic objects are outputted in accordance with the organizational scheme. The device detects user's selection of one of the holographic objects representing one of the plurality of digital content items. The device determines a desired operation to be performed on the selected digital content item based on user's input. The desired operation is performed on the selected holographic object within the three-dimensional space.

Embodiments of the invention are directed to a computer-program product for interacting with holographic objects representing a hierarchy, the computer-program product including a computer-readable storage medium having program instructions embodied therewith. The program instructions are executable by a processor to cause the processor to perform a method. A non-limiting example of the method includes grouping a plurality of digital content items hosted by a mobile device into a plurality of groups based on an organizational scheme. A holography module of the device outputs one or more holographic objects representing the plurality of digital content items in three-dimensional space. The one or more holographic objects are outputted in accordance with the organizational scheme. The device detects user's selection of one of the holographic objects representing one of the plurality of digital content items. The device determines a desired operation to be performed on the selected digital content item based on user's input. The desired operation is performed on the selected holographic object within the three-dimensional space.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an exemplary diagram of a possible data processing environment in which illustrative embodiments may be implemented;

FIG. 2 shows a holographic system with user remote object interaction, in accordance with an embodiment of the present invention;

FIG. 3 depicts a holographic hierarchy manipulation system, in accordance with an embodiment of the present invention;

FIG. 4 is a block diagram of a mobile device, in accordance with an alternative embodiment of the present invention;

FIG. 5 is a conceptual view illustrating a holographic object presented by a holography module, in accordance with embodiments of the present invention;

FIG. 6 is a conceptual diagram illustrating clustering of digital content items into a plurality of groups based on characteristics of each digital content item, in accordance with embodiments of the present invention

FIGS. 7A-7C are diagrams illustrating user's capability of navigating a holographic hierarchy, in accordance with embodiments of the present invention;

FIG. 8 is a conceptual diagram illustrating user-controlled movement of a holographic object in 3D space, in accordance with embodiments of the present invention;

FIG. 9 shows a flow diagram of a method for interacting with holographic objects representing a hierarchy, in accordance with embodiments of the present invention; and

FIG. 10 is a block diagram of a computer system for implementing some or all aspects of the holographic hierarchy manipulation system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, the methods and systems described below may advantageously be employed to enable multiple users of a holographic system to interact with and manipulate 3D holographic objects representing a hierarchy, such as a file structure. The holographic system may include cameras and sensors used to capture interaction behavior of participating users from various angles to identify if a user is using a finger gesture to select and interact (i.e. selection, touch, etc.) with holographic objects. Using image analysis techniques, the holographic system extrapolates a finger direction of the user to identify the holographic objects intended to be selected. Accordingly, in some embodiments, the holographic projection system plots a holographic intersection line from the fingertip to the holographic object of a defined color of the user to signal the selection. Each user may be granted specific actions and duration for manipulation of the object. Accordingly, other users can take control of the holographic hierarchy navigation and interaction.

In an embodiment of the present invention, a holography module is configured to output holographic objects representing some kind of hierarchy and may be hosted by a computer device or a mobile device. According to an exemplary embodiment of the present invention, the holography module may utilize a laser pulse beam which generates a palpable light field at the one or more focal points. The discussion herein will often relate to outputting holographic objects in midair. However, such teachings with regard to a particular type of medium will generally apply to other types of medium as well, such as, but not limited to, stream of one or more liquids, fog, fabric, stream of dust particles, and the like. Some embodiments further contemplate that a control region for each hologram may be spatially displaced (e.g., 1-2 inches to the right). In other words, users may manipulate their fingers, stylus or any other object configured to manipulate a selected 3D holographic object at some distance from the selected holographic object.

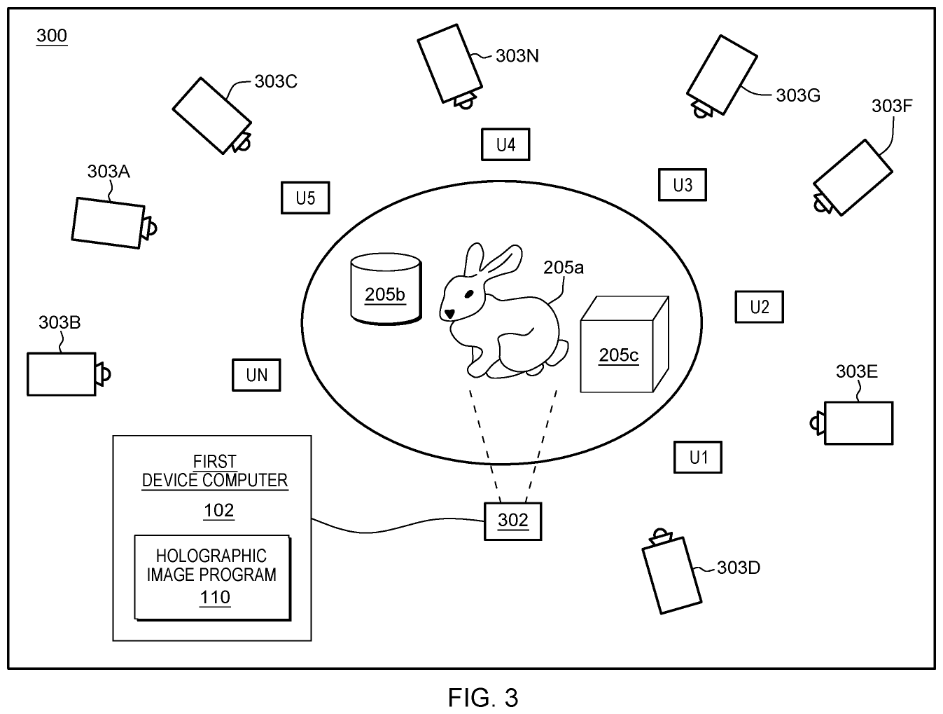

FIG. 3 depicts an exemplary holographic hierarchy manipulation system, in accordance with an embodiment of the present invention. The system 300 is in an environment in which the holographic objects are to be manipulated in. The environment may be a conference room, meeting room or other physical location.

Within the holographic hierarchy manipulation system 300 is a projector 302 which projects at least one 3D holographic object 205a-205c midair from the table or surface. In some embodiments, the 3D holographic objects may be produced by one or more mobile devices, as described below. Also present within the holographic hierarchy manipulation system 300 is a plurality of cameras 303a-303n. The cameras 303a-303n observe and capture images of the users U1-UN for identification of selected holographic object from multiple angles. It should be noted that the placement of the cameras 303a-303n and the projector 302 may be present within the environment in locations other than what is shown in FIG. 3.

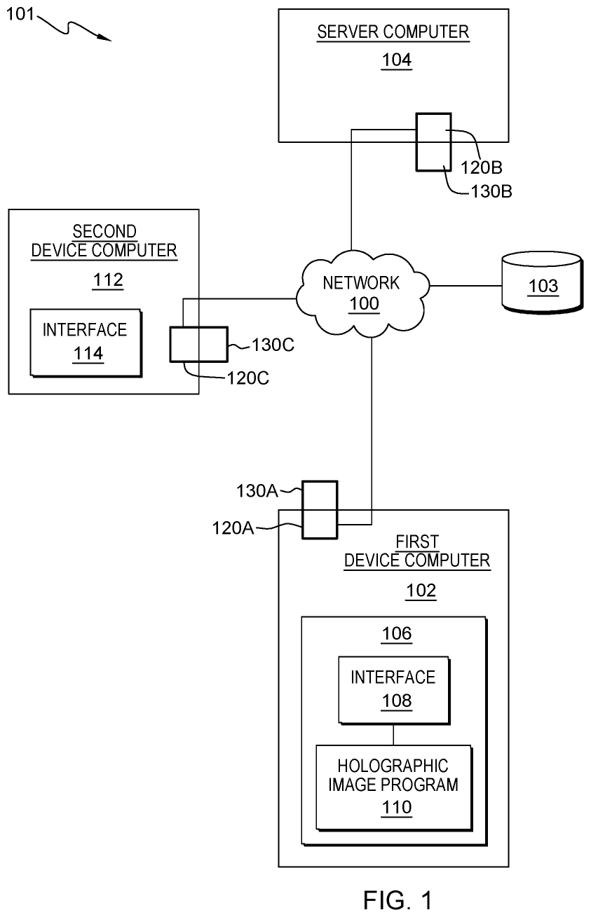

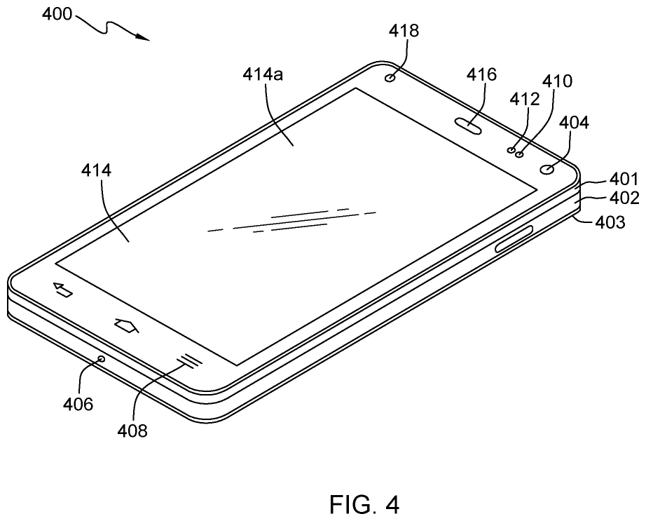

A computer, such as first device computer 102, as shown in FIG. 1, may also be present within the holographic hierarchy manipulation system 300. The first device computer 102 may define hologram properties, define user control policy, process hierarchy manipulation requests received from users and the like. The projector 302 and the plurality of cameras 303a-303n can each contain a second device computer 112 as shown in FIG. 1. Alternatively, the projector 302 and the plurality of cameras 303a-303n can each be contained within a mobile device 400 shown in FIG. 4. The plurality of cameras 303a-303n, the projector 302, and the first device computer 102 may be connected through a network 100. Furthermore, a server computer 104 may be present within the network 100. The first device computer 102, second device computer 112 and server computer 104 may access a repository 103 through a network 100. The repository 103 may contain control policy of 3D holographic objects, user profiles, pre-configured clusters of various elements grouped based on certain criteria, and other information related to manipulation and relocation of 3D holographic objects within the presented hierarchy.

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 101 is a network of computers in which illustrative embodiments may be implemented. Network data processing system 101 contains network 100, which is the medium used to provide communication links between various devices and computers connected together within network data processing system 101. Network 100 may include connections, such as wire, wireless communication links, or fiber optic cables.

In the depicted example, a first device computer 102, a second device computer 112, a repository 103, and a server computer 104 connect to network 100. In other exemplary embodiments, network data processing system 101 may include additional client or device computers, mobile devices, storage devices or repositories, server computers, and other devices not shown.

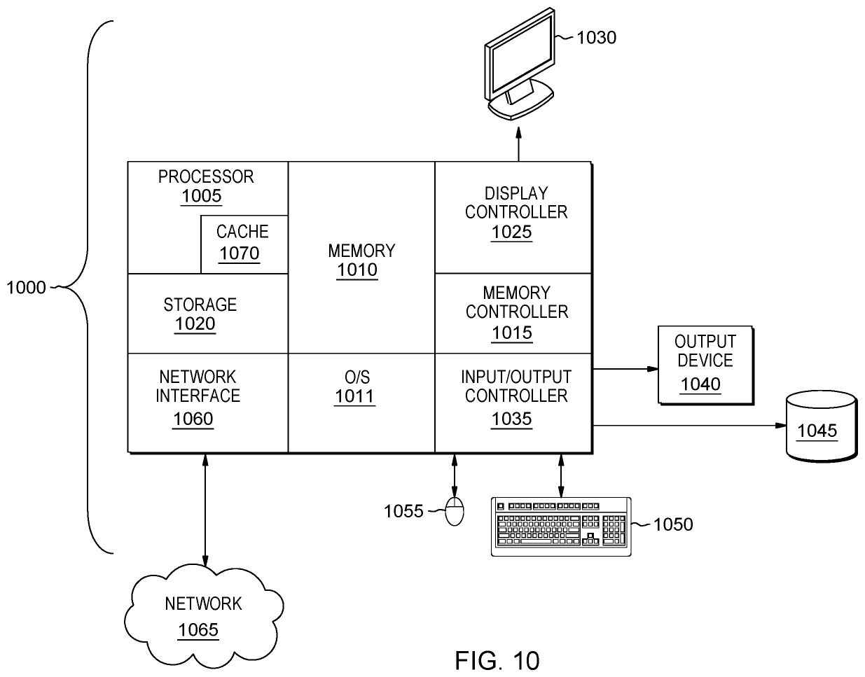

The first device computer 102 may contain a holography module 106. Holography module 106 may contain an interface 108, which may accept commands and data entry from a user. The commands may be regarding hologram properties, policy and priority of users regarding the manipulation of 3D holographic objects. The interface can be, for example, a command line interface, a graphical user interface (GUI), a natural user interface (NUI) a touch user interface (TUI), a web-based interface, or an application programming interface for defining the hologram interaction policies. The holography module 106 preferably includes holographic image program 110. While not shown, it may be desirable to have the holographic image program 110 be present on the server computer 104, or the second device computer 112. The first device computer 102, server computer 104 and second device computer 112 each includes a set of internal components 120a, 120b and 120c, respectively, and a set of external components 130a, 130b and 130c, respectively further illustrated in FIG. 10.

The second device computer 112 may contain an interface 114, which may accept commands and data entry from a user. The commands may be regarding holographic image projection. The interface can be, for example, a command line interface, a graphical user interface (GUI), a natural user interface (NUI) or a touch user interface (TUI).

In the depicted example, server computer 104 provides information, such as boot files, operating system images, and applications to the first device computer 102 and/or the second device computer 112. Server computer 104 can compute the information locally or extract the information from other computers on network 100. The server computer 104 may contain the holography module 106.

Program code and programs such as holographic image program 110 may be stored on at least one of one or more computer-readable tangible output storage devices 1040 shown in FIG. 10, on at least one of one or more portable computer-readable tangible storage devices as shown in FIG. 10, or on the storage unit 103 connected to network 100, or may be downloaded to a first device computer 102, a second device computer 112 or server computer 104, for use. For example, program code and programs such as holographic image program 110 may be stored on at least one of one or more storage devices on server computer 104 and downloaded to the first device computer 102, the second device computer 112 or mobile device 400 (shown in FIG. 4) over network 100 for use. Alternatively, server computer 104 can be a web server, and the program code, and programs such as holographic image program 110, may be stored on at least one of the one or more storage devices on server computer 104 and accessed by the first device computer 102 and/or the second device computer 112. In other exemplary embodiments, the program code, and programs such as holographic image program 110 may be stored on at least one of one or more computer-readable storage devices 1045 on a first device computer 102, a second device computer 112 or distributed between two or more servers.

In the depicted example, network data processing system 101 is the Internet with network 100 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 101 also may be implemented as a number of different types of networks, such as, for example, an intranet, local area network (LAN), or a wide area network (WAN). FIG. 1 is intended as an example, and not as an architectural limitation, for the different illustrative embodiments.

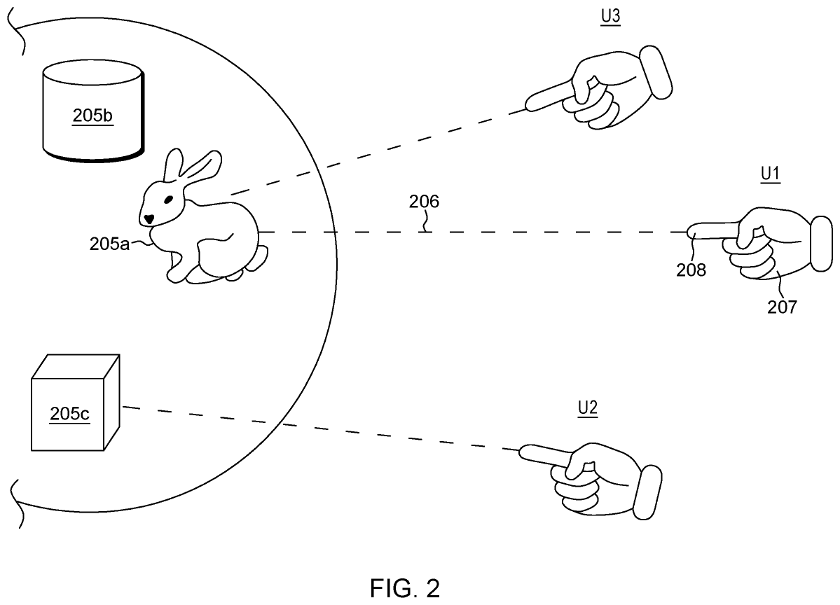

Referring back to FIG. 3, it depicts a holographic hierarchy manipulation system 300, where at least one holographic projector 302 and a plurality of cameras 303a-303n are installed in the surrounding 3D space to plot the holographic objects being projected by a projector 302 relative to the users U1-UN within the holographic hierarchy manipulation system 300. Cameras 303a-303n installed in the environment identify users using their finger with the intention of selecting the 3D holographic object 205a-205c. The holographic hierarchy manipulation system 300, via the first device computer 110 and cameras 303a-303n, identifies an extrapolated finger 208 direction of a hand 207 of the user (as shown in FIG. 2) and if the finger direction of the user intersects with any 3D holographic objects 205a-205c. Other sensors may also be used to extrapolate finger direction within the holographic object movement control system 300. When a user is controlling the movement of the 3D holographic object, the object or portion of the object may be a color assigned to the user. Referring to FIG. 2, the extrapolated finger direction would identify both users U1 and U3 as intersecting with the 3D holographic object 205a in the shape of a bunny and extrapolated finger direction of user U2 as intersecting with the 3D holographic object 205c of a cube.

Prior to a user controlling the movement of a 3D holographic object, a hologram interaction policy may be determined. The hologram interaction policy includes a definition of the shape of the 3D holographic object (i.e. square, rectangular, bunny, etc.); definition of controls on each side of object that users can interact (i.e., touch interface with areas or buttons); definition of operations that only one user can perform at time (i.e., rotation or movement of the object); and definition of a duration of time for specific operations.

A user control policy mapping may also be determined. The user control policy may define user hierarchy for control of objects. For example, priority manager=1, team lead=2, other member queue on first come basis. Users will be queued until the operation is complete. Each user has a defined color mapping such that when they select, manipulate or move an object, the line from the user to the object is represented as active by showing the color for that user. The line could be configured to pulse or stay solid.

In certain embodiments, holographic objects produced by the holographic object movement control system 300 may be rendered by one or more mobile devices instead of, or in cooperation with stationary devices, such as holographic projectors 302, digital TVs, desktop computers, and the like. Mobile devices presented herein may be implemented using a variety of different types of devices. Examples of such devices include cellular phones, smartphones, user equipment, laptop computers, digital broadcast terminals, personal digital assistants (PDAs), portable multimedia players (PMPs), navigators, portable computers (PCs), slate PCs, tablet PCs, ultrabooks, wearable devices (for example, smart watches, smart glasses, head-mounted displays (HMDs)), and the like. By way of non-limiting example only, further description will be made with reference to particular types of mobile devices. However, such teachings apply equally to other types of devices, such as those types noted above.

Reference is now made to FIG. 4, where FIG. 4 is a conceptual view of one example of a mobile device related to another embodiment of the present invention. Implementing all of the illustrated components is not a requirement, and that greater or fewer components may alternatively be implemented. The mobile device 400 is described with reference to a bar-type terminal body. However, the mobile device 400 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. The discussion herein will often relate to a particular type of mobile device (for example, bar-type, watch-type, glasses-type, and the like). However, such teachings with regard to a particular type of mobile device will generally apply to other types of mobile devices as well.

The mobile device 400 will generally include a case (for example, frame, housing, cover, and the like) forming the appearance of the device. In this embodiment, the case is formed using a front case 401 and a rear case 402. Various electronic components are incorporated into a space formed between the front case 401 and the rear case 402. At least one middle case may be additionally positioned between the front case 401 and the rear case 402.

The display unit 414 is shown located on the front side of the device body to output information. As illustrated, a window 414a of the display unit 414 may be mounted to the front case 401 to form the front surface of the device body together with the front case 401.

In some embodiments, electronic components may also be mounted to the rear case 402. Examples of such electronic components include a detachable battery, an identification module, a memory card, and the like. Rear cover 403 is shown covering the electronic components, and this cover may be detachably coupled to the rear case 402. Therefore, when the rear cover 403 is detached from the rear case 402, the electronic components mounted to the rear case 402 are externally exposed.

If desired, the mobile device 400 may include a waterproofing unit for preventing the introduction of water into the terminal body. For example, the waterproofing unit may include a waterproofing member which is located between the window 414a and the front case 401, between the front case 401 and the rear case 402, or between the rear case 402 and the rear cover 403, to hermetically seal an inner space when those cases are coupled.

The mobile device 400 may be provided with the display unit 414, the holography module 416, the proximity sensor 410, the illumination sensor 412, the projector module 418, the camera 404, the manipulating unit 408, the microphone 406, and the like.

FIG. 4 depicts certain components as arranged on the mobile device. However, alternative arrangements are possible and within the teachings of the instant disclosure. Some components may be omitted or rearranged. For example, the manipulation unit 408 may be located on another surface of the device body.

The display unit 414 outputs information processed in the mobile device 400. The display unit 414 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof. The display unit 414 may be implemented using two display devices, which can implement the same or different display technology. For instance, a plurality of the display units 414 may be arranged on one side, either spaced apart from each other, or these devices may be integrated, or these devices may be arranged on different surfaces.

The manipulation unit 408 is an example of the user input unit, which may be manipulated by a user to provide input to the mobile device 400. The manipulation unit 408 may also be commonly referred to as a manipulating portion and may employ any tactile method that allows the user to perform manipulation such as touch, push, scroll, or the like. The manipulation unit 408 may also employ any non-tactile method that allows the user to perform manipulation such as proximity touch, hovering, or the like.

FIG. 4 illustrates the manipulation unit 408 as a touch key, but possible alternatives include a mechanical key, a push key, a touch key, and combinations thereof. Input received at the manipulation unit 408 may be used in various ways. For example, the manipulation unit 408 may be used by the user to provide an input to a menu, home key, cancel, search, or the like.

The microphone 406 is shown located at an end of the mobile device 400, but other locations are possible. If desired, multiple microphones may be implemented, with such an arrangement permitting the receiving of stereo sounds.

Meanwhile, the mobile device 400, according to one embodiment of the present invention, may further include a projector module 418 and/or a holography module 416. The projector module 418 may perform an image projector function using the mobile device 400. The projector module 418 may display an object identical to or partially different from the image displayed on the display 414 on an external screen or wall according to a control signal of a controller.

The projector module 418 may be classified into a CRT (cathode ray tube) module, LCD (liquid crystal display) module and a DLP (digital light processing) module in accordance with a display device type. Particularly, the DLP module may enable an image, which is generated by reflecting light generated from the light source on a DMD (digital micro-mirror device) chip, to be enlarged and projected. It may be advantageous in reducing the size of the projector module 418.

Preferably, the projector module 418 can project the object toward a prescribed direction. It is apparent that the projector module 418 may be disposed at any position of the mobile device 400, if necessary. The holography module 416 can include a holography storage unit, a holography output unit and, if necessary, a holography reflecting unit. The holography module 416 can be configured to output a 3D holographic object on a preset space.

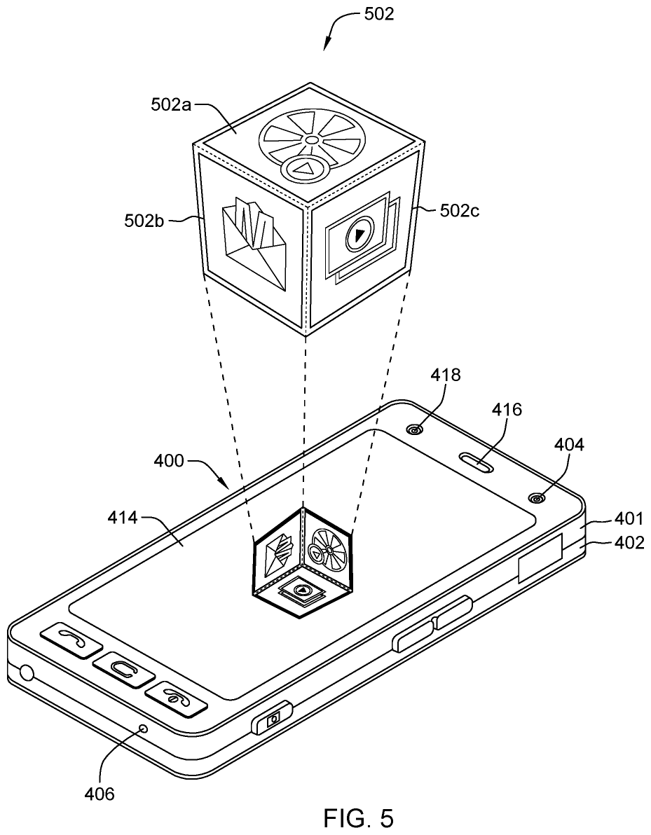

The terminal body may be provided with the holography module 416. The holography module 416 may be configured to output a holographic object 502 (see FIG. 5) on the front surface of the mobile device body, for example, at a space on the display unit 414. The drawings exemplarily illustrate that the holography module 416 is disposed on the front surface of the mobile device 400.

The holography module 416 may be disposed on the rear surface of the terminal body to output the holographic object 502 to a space on the rear surface.

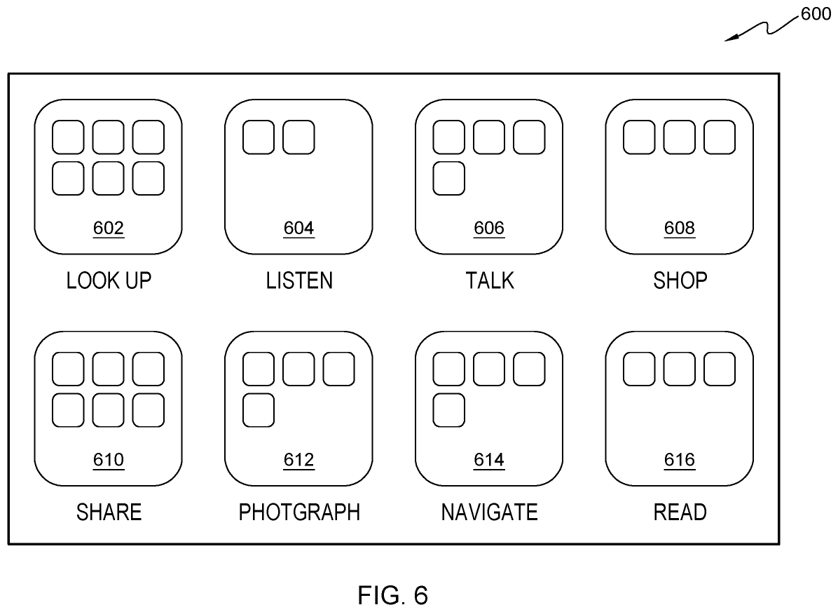

Hereinafter, a method of projecting and manipulating holographic objects will be described in greater detail with reference to FIGS. 6 to 9. A location and an object-projection direction of the holography module 416 can be identical to those of the above-mentioned projector module 418.

FIG. 5 is a conceptual view illustrating a holographic object presented by a holography module, in accordance with embodiments of the present invention.

As illustrated in FIG. 5, the holography module 416 may be disposed on the front surface of the mobile device 400. For example, the holography module 416 may be disposed to overlap the display unit 414 so as to output the holographic object 502 along with visual information output on the display unit 414, or independently output the holographic object 502 when the display unit 414 is powered off. The holography module 416 may be mounted onto a bezel portion which surrounds the display unit 414.

The mounting position of the holography module 416 and the output space of the holographic object 502 may not be limited to those. The holography module 416 may be configured to be rotatable or popped up, and also be detachably installed as a separate device on the body of mobile device 400. The holographic object 502 may be output to a space, which is irrelevant to an installation direction of the holography module 416, in a tilting manner or by employing a separate reflection structure.

The holographic object 502 which can be represented by the holography module 416 may include both a two-dimensional (2D) monoscopic image and a 3D stereoscopic image.

Monoscopic imaging is a method of providing the same image to both eyes, namely, a method in which a polyhedron, which is generated by at least one point, line, surface or a combination thereof, is disposed on a virtual stereoscopic space and an image of the polyhedron viewed from a specific viewpoint is output.

Stereoscopic imaging is a method of providing different images to both eyes, respectively, namely, a method using a principle that the human being feels stereoscopic when viewing an object with two eyes. That is, the two eyes of the human being view different monoscopic images when viewing the same object, due to a distance therebetween. The different monoscopic images are transferred to the brain through the retina, and unified (combined) in the brain, such that depth and reality of a stereoscopic image can be felt. Therefore, although slightly different in persons, binocular disparity due to the distance between both eyes brings about stereoscopic feeling. The stereoscopic imaging is a method of displaying an image using the binocular disparity.

The holographic object 502 which is generated by the holography module 416 to be explained later may include both the monoscopic image and the stereoscopic image. Hereinafter, for the sake of explanation, an image representation according to the monoscopic imaging method may include an image representation according to the stereoscopic imaging method.

Hereinafter, description will be given in detail of a method of representing (or realizing) the holographic object 502, which may be applied to the exemplary embodiments disclosed herein, and a structure for implementing (realizing) the method.

An image output through the display unit 414 merely records only a distribution of bright and dark surfaces of an object, whereas the holographic object 502 may be understood as an image which simultaneously accumulates and reproduces all of information which light as wave contains, namely, amplitude and phase.

FIG. 6 is a conceptual diagram illustrating clustering of digital content items into a plurality of groups based on characteristics of each digital content item, in accordance with embodiments of the present invention. Digital content items represent any item stored in a digital format, including but not limited to digital media items. Examples of digital content items include but are not limited to audio files, video files, image files, text files, document files, spreadsheet files, multimedia files, data files, and playlists and metadata associated with these items. Metadata is any information, in any form or format, about the digital items. Examples of metadata include artist information, owner information, publication date, photographs, graphics, descriptive text, file size information, and the like.

For illustrative purposes only, one embodiment of clustering mobile applications hosted by a mobile device is discussed below. For example, a first group 602 of the hierarchy 600 can be dedicated to search engine applications, second group 604 can be dedicated to music apps, third group 606 can be dedicated to communication apps, fourth group 608 can contain user's favorite online shopping applications, fifth group 610 can be dedicated to social networks, sixth group 612 can group photography related applications, seventh group 614 can be dedicated to navigation engines, eighth group 616 could be dedicated to user's favorite reading apps, and so on. As another non-limiting example, users or a specific program running on the mobile device 400 may organize apps in different groups in order of how often users use them. In one non-limited embodiment, each group 602-616 may be associated with a particular folder.

According to an embodiment of the present invention, each group 602-616 may further include one or more subgroups. Accordingly, next level of hierarchy could include files produced using a plurality of mobile applications included in groups 602-616. All the files could be further arranged in accordance with some kind of organizational scheme. It is worth noting that multiple factors, each of which could be used individually to organize elements into a hierarchy, can also be combined to create a hierarchical organization. Such a hierarchical organization takes into account multiple factors of information. For example, the application files used previously could be organized first by date of their creation and then by their expected frequency of use. Those skilled in the art will understand that other combinations of factors are possible and would fall within the scope of the various embodiments of the invention.

According to embodiments of the present invention, the user can also manually select a grouping factor across each level of the hierarchy. It will be noted that in case of a user interface on the mobile device 400, the user interface generates several folders representing groupings 602-616, along with the corresponding structures at each level of the hierarchy. In order to navigate this hierarchy on the mobile device 400 a user may select a particular folder/app/file generated by a particular app, and so on. Advantageously, various embodiments of the present invention provide users an opportunity to navigate this hierarchy in a structural manner using a plurality of 3D holographic objects. Each of the plurality of 3D holographic objects can represent a particular element of the hierarchy. For example, top-level 3D holographic objects can represent clusters 602-616.

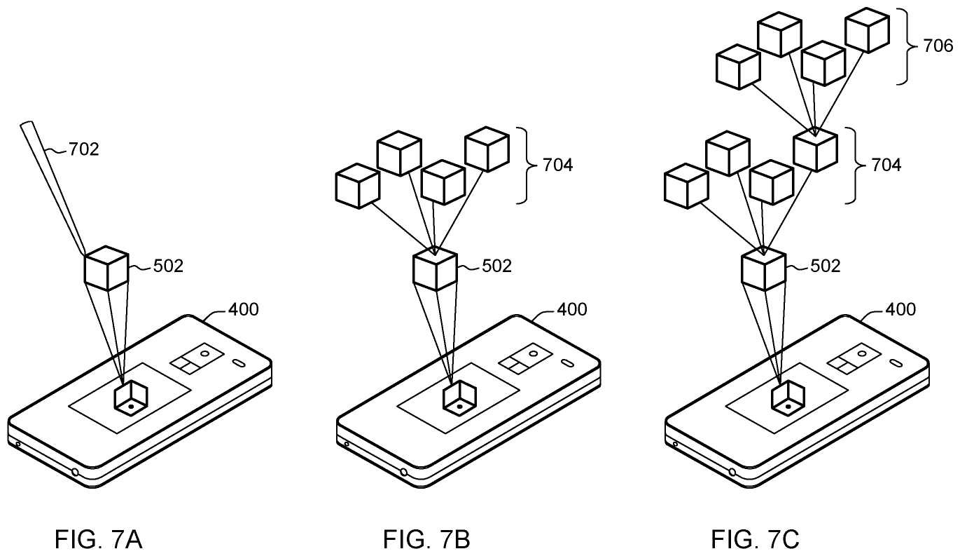

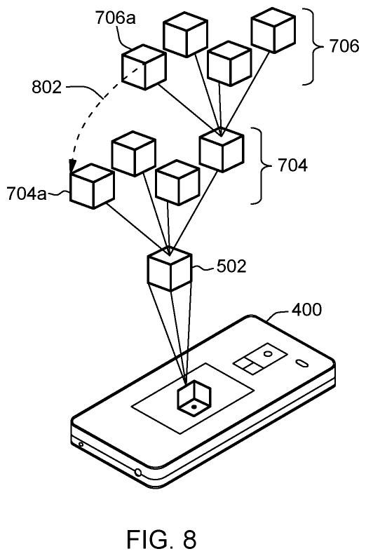

In an embodiment, the holographic hierarchy manipulation system 300 may be configured to visually indicate relationships between various elements of the hierarchy using, for example, arrows, solid or dashed lines, geometric shapes, and the like. In some embodiments, the 3D holographic objects shown in FIGS. 7A-7C and 8 could be color-coded to indicate a particular organizational scheme. In other embodiments, the holographic display of the 3D holographic objects may be updated dynamically by the holography module 106, 416 of the holographic hierarchy manipulation system 300.

FIGS. 7A-7C are diagrams illustrating user's capability of navigating a holographic hierarchy, in accordance with embodiments of the present invention. More specifically, at least one holographic projector 302 of the holographic hierarchy manipulation system 300 installed in the surrounding 3D space projects many 3D holographic objects 502, 704, 706 at the same time in accordance with the organizational scheme. In an alternative embodiment, the plurality of holographic objects 502, 704, 706 may be projected by one or more holography modules 416 of one or more mobile devices 400 shown in FIG. 4. In either embodiment, any user present in the surrounding space should be able to engage with any presented 3D holographic object of interest very quickly. It should be noted that the holography module 106, 416 knows the 3D coordinates of each of multiple holographic objects 502, 704, 706.

According to an embodiment of the present invention, the three orthogonal axes (e.g., x, y, z) in three-dimensional space may be used by the holography module 106, 416 to denote hierarchical relationships between elements. In one non-limiting example, the 3D holographic objects 704 representing a Microsoft Word document and a Microsoft Excel chart would be positioned by the holography module 106, 416 at the same Z-axis level displaced from each other by some predefined distance in X, Y plane. Each of the users is enabled to interact with and manipulate the 3D holographic objects 502, 704, 706 in a hierarchical manner. For instance, as shown in FIG. 7A, users can select the 3D holographic object 502 by touching the 3D holographic object 502 using a stylus 702 or by pointing their finger (as shown in FIG. 2). In an embodiment of the present invention, once the 3D holographic object 502 is selected the holography module 416 may change its appearance (e.g. color, brightness, etc.). Furthermore, the holography module 106, 416 may be operable to perform a manipulation command associated with the selected object based on the user input. In one embodiment, users could create another sub-group under the 3D holographic object 502 or change the level of a hierarchical path, as described below. As another non-limiting example, navigation path through the hierarchy may be personalized based on user's preferences. The holography module 106, 416 allows a user to customize holographic displays and features to create a personalized “experience” with the holographic hierarchy. For example, users can create customized navigation path through the holographic hierarchy.

According to an embodiment, the holography module 106, 416 outputs the holographic hierarchy as a tree structure of holographic objects representing hierarchical relationships between the plurality of digital content items. FIGS. 7B and 7C show groups and subgroups of holographic objects in such a way that no holographic object overlaps any other objects during the hierarchical navigation operation. In an embodiment, users are enabled to perform operations (e.g., open, close, view, edit, update, and the like) on elements of the holographic hierarchy (e.g., digital content items) represented by the 3D holographic objects 502, 704, 706 at any displayed level. In various embodiments, each 3D holographic object 502, 704, 706 may be moveable/rotatable/scalable. Furthermore, each face of each 3D holographic object 502, 704, 706 may display a 2D image or text. In one embodiment, such image or text could be static. Rotation of the corresponding 3D holographic object enables users to see images/text on various faces 502a-502c of the 3D holographic object 502, as shown in FIG. 5. In yet another embodiment, the holography module 106, 416 may provide a real-time event streaming capability. For example, a real-time event streaming capability may allow capture and visualization of real-time external incoming incidents on various faces of the plurality of holographic objects 502, 704, 706. Such external incoming incidents may include but are not limited to market data, news, external system of business incidents, and internal significant changes, for example, meteor visual effects.

Referring again to FIGS. 7A-7C, these figures illustrate that the holographic hierarchy manipulation system 300 provides users multiple-way holographic hierarchy navigation capability, as well as other control functions, such as, but not limited to digital content item selection, by using a plurality of selectable 3D holographic objects 502, 704, 706. A user can drill down into a relevant digital content item by selecting (pointing to or touching with a pointing device 702) the 3D holographic object 502 representing a relevant group of elements. The 3D holographic objects 502, 704, 706 presented by the holography module 106, 416 may take any number of forms including, for example simple, complex, etc. A user may optionally edit, customize, etc., aspects of a 3D holographic object (using, for example, a holographic object settings tool). Further, the user may optionally create, alter, remove, reposition, etc. groupings of one or more 3D holographic objects 502, 704, 706. The 3D holographic objects 502, 704, 706 may be organized in groups based on any of a number of organizational paradigms (e.g., nested, stacked, and hierarchical, etc.) The placement, location, sizing, arrangement, etc., of the 3D holographic objects 502, 704, 706 may be responsive, flexible, extensible, and dynamically configurable. In various examples, the outlined transactions/transfers/actions associated with the holographic hierarchy interactions may include multiple storage domains, multiple users, and multiple applications and devices. By interacting with the holographic hierarchy, a user may obtain information about a particular document and the path associated with the particular document. The user may obtain this information by interacting with a 3D holographic object associated with the file and may, therefore, see the entire path along with corresponding transactions/transfers/actions. Under an alternative embodiment, the selected 3D holographic object may visually encode information of the path and the associated transactions/transfers/actions using any combination of colors, shapes, icons, graphics, fonts, design and presentation formats to encode such information into the selected 3D holographic object. It should be noted that under the example provided in FIGS. 7A-7C regarding the transactions/transfers/actions associated with a particular application or a particular file, the holography module 106, 416 traces the document path and associated activity even when the file moves physically from one group to another group (e.g., from one digital content item to another digital content item).

According to one embodiment of the present invention, the holographic hierarchy manipulation system 300 may include the mobile device 400 configured to project one or more 3D holographic objects 502, 704, 706 in midair. According to another embodiment of the present invention, the holographic hierarchy manipulation system 300 comprising a plurality of 3D holographic objects projected in midair above a central point of a location by a projector is disclosed. The location further comprising a plurality of cameras around the central point of the location, and a computer within the location and in communication with the projector comprising at least one processor, one or more memories, one or more computer readable storage media having program instructions executable by the computer to perform the program instructions. In one embodiment, the 3D holographic object 502 shown in FIG. 7A is a unit of a cluster of digital content items that may be organized in the cluster based on any of a number of organizational schemes (e.g., based on metadata properties).

With reference now to FIG. 7B, user's interaction with the 3D holographic object 502 representing a cluster shown in FIG. 7A, provides access to and interaction abilities with additional 3D holographic objects 704 representing clusters within clusters (sub-clusters). In one embodiment, each cluster will be assigned a unique cluster ID by the holography module 106, 416. Each of the 3D holographic objects 704 at this level of hierarchy may further represent a sub-cluster of digital content items (including, for example, web browser applications, widget or gadget engines, and or other applications, as necessary), and/or a sub-cluster of data files. At this point, lower level sub-cluster and/or corresponding application files and/or data files are still hidden from the user.

With reference now to FIG. 7C, the user can then select one of the 3D holographic objects 704 representing sub-cluster elements of the hierarchy and can “drill down” into a plurality of 3D holographic objects 706 representing underlying elements of hierarchical structure (e.g., application files and/or data files). That is, in one embodiment, upon detecting a user's selection of a 3D holographic object, lower level hierarchical structure beneath the selected element represented by the selected 3D holographic object may be presented by the holography module 106, 416. At this point, the user may interact directly with an application (that can be downloaded to and executed on the respective mobile device 400) or a website by interacting with a corresponding 3D holographic object 706.

FIG. 8 is a conceptual diagram illustrating user-controlled movement of a holographic object in 3D space, in accordance with embodiments of the present invention. More specifically, FIG. 8 illustrates how the user can move 802 one of the plurality of 3D holographic objects from one group (sub-group/sub-cluster) to another group (sub-group/sub-cluster). Embodiments of the present invention provide a passive/active stylus 702 (shown in FIG. 7A) configured for interaction with a 3D holographic object, such as the holographic object 706a shown in FIG. 8. The term “active” is used herein to refer to circuit components within the stylus that are powered by an electrical energy source, such as a battery or other power supply. Examples of active components include integrated circuits, operational amplifiers, comparators, buffers, inverters, and the like. This contrasts with “passive” components that do not require an energy source, examples of which include capacitors, resistors, inductors, and transmission lines. According to embodiments of the present invention, the 3D holographic objects representing grouped elements (e.g., clusters), such as, for example 3D holographic objects 704 can be nested to a number of levels, but because the hierarchy navigation mode is based upon the linear progression through each level of hierarchy, the most common resort for users is to avoid including many elements on a single group, but rather to create more groups. Accordingly, the holography module 106, 416 visualizes such changes in 3D space.

The holography module 106, 416 may further provide a set of functions or services that are used by the users of the system to perform various operations (e.g., open windows on a display screen of the mobile device 400, move files, open files, and display message boxes). Advantageously, the holography module 106, 416 provides an interactive holographic mechanism for accessing hierarchy elements represented by the projected 3D holographic objects 502, 704, 706. When the user manipulates a selected 3D holographic object, the accessing mechanism of the holography module 106, 416 can, for example, launch the associated element on the mobile device 400 or on a remote computing device, for example, if necessary (e.g., when the mobile device 400 is unable to locally execute the application associated with the selected 3D holographic object). As noted above, FIG. 8 illustrates the user may also move 802 the selected 3D holographic object, for example 3D holographic object 706a from one sub-group of the hierarchy (represented by the plurality of 3D holographic objects 706) to a position 704a in the different sub-group of the hierarchy (represented by the plurality of 3D holographic objects 704) even if those sub-groups are at different levels of hierarchy.

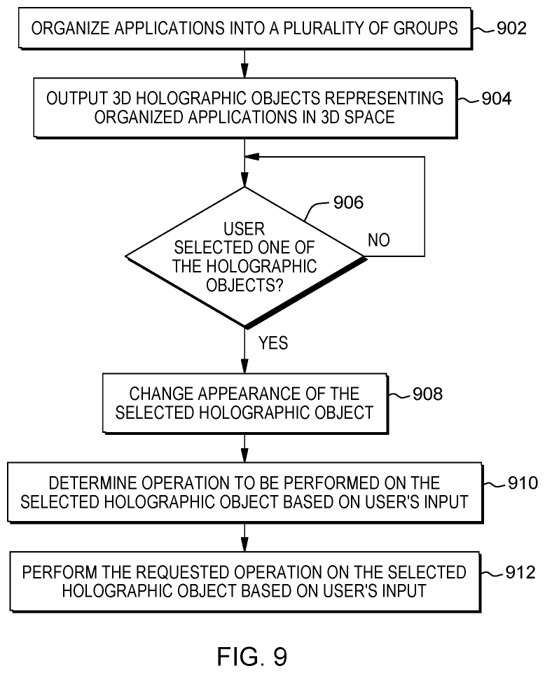

FIG. 9 is a flow diagram of a method for interacting with holographic objects representing a hierarchy, in accordance with embodiments of the present invention. According to embodiments of the present invention, a user can manually organize digital content items hosted by the mobile device 400 or another computing device associated with the holographic hierarchy manipulation system 300 based on an organizational scheme. Alternatively, at block 902, the holography module 106, 416 can automatically organize the plurality of digital content items into groups or sub-groups via default user-defined parameters and/or user-defined business rules, for example. As noted above, the generated hierarchical arrangement may take into account multiple factors of information. Those skilled in the art will understand that various combinations of factors are possible and would fall within the scope of the various embodiments of the invention.

At block 904, the holography module 106, 416 outputs one or more 3D holographic objects, such as holographic object 502 illustrated in FIG. 5, and/or objects 704-706 illustrated in FIGS. 7A-7C and FIG. 8. According to embodiments of the present invention, users can select 3D holographic objects they would like to manipulate using a pointing device, such as stylus 702, or by pointing their fingers. For example, a 3D holographic object is selected through pointing at the 3D holographic object. Referring back to FIG. 2, in an embodiment, from the extrapolated finger direction of the user (which may be measured by a sensor installed in the mobile device 400, for example) for the identified 3D holographic object selected, the holography module 106, 416 may plot a holographic intersection line 206 from the fingertip 208 to the 3D holographic object. Software controls the projection of the line from user to the 3D holographic object to visualize what the user is attempting to select. This allows the user to move the finger accordingly until the desired 3D holographic object is selected. The selection could be configured to occur based on time parameter of pointing at an object (i.e. 3 or 5 seconds). The line from the user to the 3D holographic object (single user access) or side of the 3D holographic object (multi-user access) will change color to that of user mapping. Each user may have a defined color mapping such that when they select or manipulate the 3D holographic object, the line from the user to the 3D holographic object is represented as active by showing the color for that user. The line could be configured to pulse or stay solid.

At block 906, the holography module 106, 416 continuously monitors if any of the users in the vicinity of the system selected any of the presented 3D holographic objects. In response to determining that one of the users selected one of the presented 3D holographic objects (decision block 906, “Yes” branch), the holography module 106, 416 may change the appearance of the selected holographic object. For instance, at block 908, the selected holographic object may change color in accordance with a predetermined color scheme.

According to an embodiment of the present invention, at block 910, the holography module 106, 416 may determine the operation to be performed on the selected holographic object based on user's input. Furthermore, the data, applications or files within the presented hierarchy represented by a plurality of 3D holographic objects can be drilled down or drilled up in a hierarchical fashion. A hierarchical path may be traversed or explored during an analysis which enables a user to more efficiently and continuously manipulate various elements of the hierarchy. In other words, users may have the capability to select one or more 3D holographic objects 502, 704, 706 and perform various operations on them; such as dragging and dropping them to group/re-group/de-group, opening a file(s) associated with the selected holographic object(s), closing a file(s) associated with the selected 3D holographic object(s), and the like. In one embodiment, the user may indicate a desire to perform certain operations on one of the presented 3D holographic object by multiple taps, for example. In one embodiment, the user may need to tap a 3D holographic object once to select, tap the holographic object twice to open the corresponding document/file, and tap the holographic object three times to move it, and so on.

According to an embodiment of the present invention, in response to receiving all information related to manipulation of user-selected 3D holographic object, at block 912, the holography module 106, 416 performs the requested operation on the selected holographic object (e.g., changes the position (moves) of the selected 3D holographic object) based on the input information received from the user. It should be noted that while performing the requested operation, the holographic hierarchy manipulation system 300 may control the projection aspects (such as a spacing/distance between the presented 3D holographic objects) and may also ensure that manipulated holographic objects do not overlap with each other and may maintain proper hierarchical order of the presented information.

FIG. 10 is a block diagram of a computer system 1000 for implementing some or all aspects of the holographic hierarchy manipulation system 300, according to some embodiments of this invention. The holographic hierarchy manipulation system 300 and methods described herein may be implemented in hardware, software (e.g., firmware), or a combination thereof. In some embodiments, the methods described may be implemented, at least in part, in hardware and may be part of the microprocessor of a special or general-purpose computer system 1000, such as a personal computer, workstation, minicomputer, or mainframe computer. For instance, the holographic image program 110, interfaces 108 and 114 may each be implemented as a computer system 1000 or may run on a computer system 1000.

In some embodiments, as shown in FIG. 10, the computer system 1000 includes a processor 1005, memory 1010 coupled to a memory controller 1015, and one or more input devices 1045 and/or output devices 1040, such as peripherals, that are communicatively coupled via a local I/O controller 1035. These devices 1040 and 1045 may include, for example, a printer, a scanner, a microphone, and the like. Input devices such as a conventional keyboard 1050 and mouse 1055 may be coupled to the I/O controller 1035. The I/O controller 1035 may be, for example, one or more buses or other wired or wireless connections, as are known in the art. The I/O controller 1035 may have additional elements, which are omitted for simplicity, such as controllers, buffers (caches), drivers, repeaters, and receivers, to enable communications.

The I/O devices 1040, 1045 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 1005 is a hardware device for executing hardware instructions or software, particularly those stored in memory 1010. The processor 1005 may be a custom made or commercially available processor, a central processing unit (CPU), an auxiliary processor among several processors associated with the computer system 1000, a semiconductor-based microprocessor (in the form of a microchip or chip set), a macroprocessor, or other device for executing instructions. The processor 1005 includes a cache 1070, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 1070 may be organized as a hierarchy of more cache levels (L1, L2, etc.).

The memory 1010 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1010 may incorporate electronic, magnetic, optical, or other types of storage media. Note that the memory 1010 may have a distributed architecture, where various components are situated remote from one another but may be accessed by the processor 1005.

The instructions in memory 1010 may include one or more separate programs, each of which comprises an ordered listing of executable instructions for implementing logical functions. In the example of FIG. 10, the instructions in the memory 1010 include a suitable operating system (OS) 1011. The operating system 1011 essentially may control the execution of other computer programs and provides scheduling, input-output control, file and data management, memory management, and communication control and related services.

Additional data, including, for example, instructions for the processor 1005 or other retrievable information, may be stored in storage 1020, which may be a storage device such as a hard disk drive or solid-state drive. The stored instructions in memory 1010 or in storage 1020 may include those enabling the processor to execute one or more aspects of the holographic hierarchy manipulation system 300 and methods of this disclosure.

The computer system 1000 may further include a display controller 1025 coupled to a display 1030. In some embodiments, the computer system 1000 may further include a network interface 1060 for coupling to a network 1065. The network 1065 may be an IP-based network for communication between the computer system 1000 and an external server, client and the like via a broadband connection. The network 1065 transmits and receives data between the computer system 1000 and external systems. In some embodiments, the network 1065 may be a managed IP network administered by a service provider. The network 1065 may be implemented in a wireless fashion, e.g., using wireless protocols and technologies, such as WiFi, WiMax, etc. The network 1065 may also be a packet-switched network such as a local area network, wide area network, metropolitan area network, the Internet, or other similar type of network environment. The network 1065 may be a fixed wireless network, a wireless local area network (LAN), a wireless wide area network (WAN) a personal area network (PAN), a virtual private network (VPN), intranet or other suitable network system and may include equipment for receiving and transmitting signals.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for interacting with holographic objects representing a hierarchy, the method comprising:
grouping a plurality of digital content items hosted by a device into a plurality of groups based on an organizational scheme;
outputting, by a holography module of the device, one or more holographic objects representing the plurality of digital content items in three-dimensional space, wherein the one or more holographic objects are outputted in accordance with the organizational scheme;
detecting, by the device, user's selection of one of the holographic objects representing one of the plurality of digital content items;
determining, by the holography module of the device, a desired operation to be performed on the selected digital content item based on user's input; and
performing the desired operation on the selected holographic object within the three-dimensional space.

2. The method of claim 1, wherein the digital content items are grouped based on metadata properties of each digital content item.

3. The method of claim 1, wherein outputting the one or more holographic objects further comprises outputting a tree structure of holographic objects representing hierarchical relationships between the plurality of digital content items.

4. The method of claim 3, wherein a number of levels of the outputted tree structure changes dynamically based on user's input.

5. The method of claim 1, wherein outputting the one or more holographic objects further comprises outputting at least one holographic object configured to render a dynamic stream of data.

6. The method of claim 1, wherein the one or more holographic objects are color coded in accordance with a predefined scheme.

7. The method of claim 3, wherein performing the desired operation further comprises creating a new group of the one or more holographic objects within the tree structure based on user's input.

8. A system for interacting with holographic objects representing a hierarchy, the system comprising:
a memory having computer-readable instructions; and
one or more processors for executing the computer-readable instructions, the computer-readable instructions comprising:
grouping a plurality of digital content items hosted by a device into a plurality of groups based on an organizational scheme;
outputting, by a holography module of the device, one or more holographic objects representing the plurality of digital content items in three-dimensional space, wherein the one or more holographic objects are outputted in accordance with the organizational scheme;
detecting, by the device, user's selection of one of the holographic objects representing one of the plurality of digital content items;
determining, by the holography module of the device, a desired operation to be performed on the selected digital content item based on user's input; and
performing the desired operation on the selected holographic object within the three-dimensional space.

9. The system of claim 8, wherein the digital content items are grouped based on metadata properties of each digital content item.

10. The system of claim 8, wherein the computer-readable instructions outputting the one or more holographic objects further comprise outputting a tree structure of holographic objects representing hierarchical relationships between the plurality of digital content items.

11. The system of claim 10, wherein a number of levels of the outputted tree structure changes dynamically based on user's input.

12. The system of claim 8, wherein the computer-readable instructions outputting the one or more holographic objects further comprise outputting at least one holographic object configured to render a dynamic stream of data.

13. The system of claim 8, wherein the one or more holographic objects are color coded in accordance with a predefined scheme.

14. The system of claim 10, wherein the computer-readable instructions performing the desired operation further comprise creating a new group of the one or more holographic objects within the tree structure based on user's input.

15. A computer-program product for interacting with holographic objects representing a hierarchy, the computer-program product comprising a computer-readable storage medium having program instructions embodied therewith, the program instructions executable by a processor to cause the processor to perform a method comprising:
grouping a plurality of digital content items hosted by a device into a plurality of groups based on an organizational scheme;
outputting, by a holography module of the device, one or more holographic objects representing the plurality of digital content items in three-dimensional space, wherein the one or more holographic objects are outputted in accordance with the organizational scheme;
detecting, by the device, user's selection of one of the holographic objects representing one of the plurality of digital content items;
determining, by the holography module of the device, a desired operation to be performed on the selected digital content item based on user's input; and
performing the desired operation on the selected holographic object within the three-dimensional space.

16. The computer-program product of claim 15, wherein the digital content items are grouped based on metadata properties of each digital content item.

17. The computer-program product of claim 15, wherein outputting the one or more holographic objects further comprises outputting a tree structure of holographic objects representing hierarchical relationships between the plurality of digital content items.

18. The computer-program product of claim 17, wherein a number of levels of the outputted tree structure changes dynamically based on user's input.

19. The computer-program product of claim 15, wherein outputting the one or more holographic objects further comprises outputting at least one holographic object configured to render a dynamic stream of data.

20. The computer-program product of claim 15, wherein the one or more holographic objects are color coded in accordance with a predefined scheme.
